(19) United States
(12) Patent Application Publication
(10) Pub. No.: US 2011/0315176 A1
(43) Pub. Date: Dec. 29, 2011

(54) ENGINE SPEED CONTROL FOR A PRESSURE WASHER

(75) Inventor: Richard J. Gilpatrick, Whitewater, WI (US)

(73) Assignee: Briggs & Stratton Corporation

(21) Appl. No.: 12/822,085

(22) Filed: Jun. 23, 2010

(51) Int. Cl. B08B 3/00

(52) U.S. Cl. 134/57 R

(57) ABSTRACT

A pressure washer includes a prime mover, a pump, an unloader valve, and a control mechanism. The prime mover has a speed control system, and the pump is connected to the prime mover and driven thereby during operation of the pressure washer. The unloader valve is connected to the pump and permits flow to an outlet of the pressure washer when in a first configuration, but directs the flow to a recirculation circuit when in a second configuration. The control mechanism is connected to the unloader valve, and is designed to receive a signal from the unloader valve that is related to the configuration of the unloader valve. The control mechanism conditions the signal and communicates the signal to the speed control system, where the speed of the prime mover is set at least partially as a function of the signal.

### BACKGROUND

The present invention relates generally to the field of pressure washers, such as engine control for pressure washers. More specifically, the present invention relates to a pump providing control feedback to an engine driving the pump.

A pump for a pressure washer is typically driven by a motor, such as an electric motor or a small internal combustion engine. The motor drives a cam, which translates pistons for pressurizing water. The pressurized water is then controllably released through a sprayer, such as a pressure washer spray gun. The spray gun may include a trigger to controllably allow or stop water from flowing out of the spray gun. When the trigger is in the closed position, back pressure builds in a hose coupling the pump to the spray gun. In part to help control the back pressure, such a pump typically includes an unloader valve (e.g., flow-diverting valve). Air compressors having pneumatic pumps may include a similar arrangement.

The unloader valve is responsive to trapped pressure between the pump and the spray gun. When the spray gun is actively spraying, the unloader valve allows water to flow to the spray gun. However, when the spray gun is not spraying but the pump is active, the unloader opens a bypass conduit allowing the pressurized water to flow from the outlet of the pump back into the inlet of the pump, forming a recirculation circuit. Recirculation of the water reduces loading on the motor and lowers pressures within the pump, increasing the life of pump components and saving energy.

### SUMMARY

One embodiment of the invention relates to a pressure washer, which includes a prime mover, a pump, an unloader valve, and a control mechanism. The prime mover has a speed control system, and the pump is driven by the prime mover during operation of the pressure washer. The unloader valve is connected to the pump and permits flow to an outlet of the pressure washer when in a first configuration, but directs the flow through a recirculation circuit when in a second configuration. The control mechanism is connected to the unloader valve, and is designed to receive a signal from the unloader valve that is related to the configuration of the unloader valve. The control mechanism conditions the signal and communicates the signal to the speed control system, where the speed of the prime mover is set at least partially as a function of the signal.

Another embodiment of the invention relates to a control system for a pressure washer. The control system includes a valve body, a valve member, and a control mechanism. The valve body has an inlet, a first outlet, and a second outlet. The inlet is designed to be connected to a manifold of a pump, the first outlet is designed to be connected to a conduit for receiving pressurized flow from the pump, and the second outlet is designed to be connected to a recirculation circuit of the pump. The valve member is moveable relative to the valve body and is designed to selectively reduce the flow to at least one of the first and second outlets. The control mechanism is connected to the valve member, and utilizes motion of the valve member to at least partially control the engine.

Yet another embodiment of the invention relates to a method for controlling the speed of an engine, the method including several steps. One step includes detecting a configuration of an unloader valve. Another step includes providing a signal indicative of the configuration. Other steps include conditioning the signal, communicating the signal to a throttle system of an engine, and adjusting the speed of the engine at least partially as a function of the signal.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, in which:

FIG. 1 is a perspective view of a pressure washer according to an exemplary embodiment of the invention.

FIG. 2 is a front view of a pump of the pressure washer of FIG. 1.

FIG. 3 is a perspective view from the rear of the pump of FIG. 2.

FIG. 4 is a first side view of a control system associated with the pump of FIG. 2.

FIG. 5 is a second side view of the control system of FIG. 4.

FIG. 6 is a sectional view of the control system of FIG. 4 along line 6-6 in a first configuration.

FIG. 7 is a sectional view of the control system of FIG. 4 along line 7-7 in a second configuration.

FIG. 8 is a perspective view of a portion of the pressure washer of FIG. 1.

FIG. 9 is a sectional view of a control system according to another exemplary embodiment of the invention.

FIG. 10 is a sectional view of a control system according to yet another exemplary embodiment of the invention.

FIG. 11 is a sectional view of a control system according to still another exemplary embodiment of the invention.

FIG. 12 is a schematic diagram of power equipment having a control system according to an exemplary embodiment of the invention.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

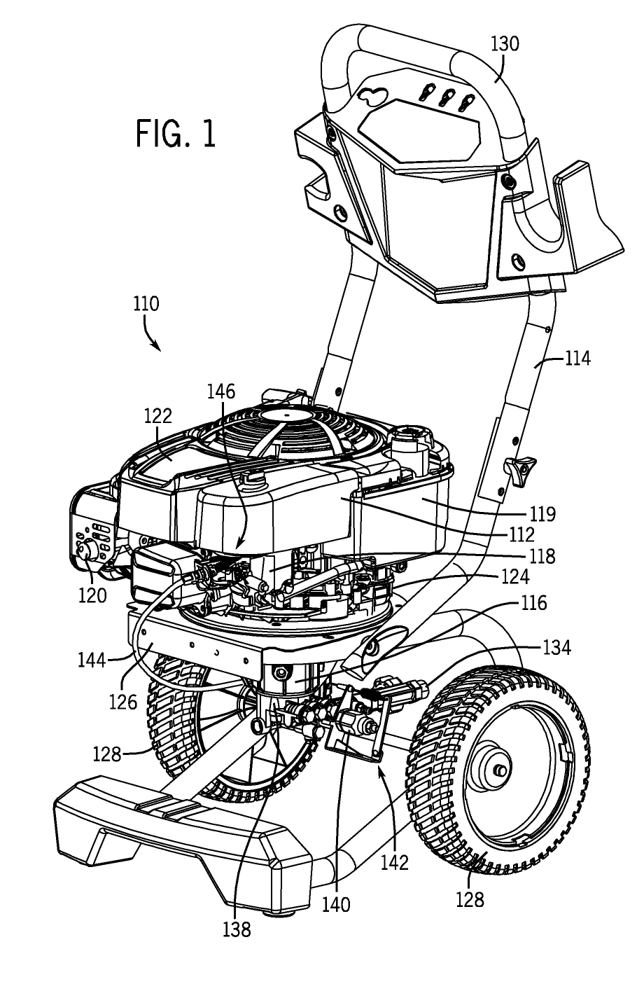

Referring to FIG. 1, power equipment in the form of a pressure washer 110 includes a prime mover, shown as engine 112, a support frame 114, and a pump 116. In some embodiments, the engine 112 is an internal combustion engine (e.g., four-stroke cycle, single-cylinder, vertically-shafted engine; twin-cylinder, horizontally-shafted engine; two-stroke cycle engine; diesel engine; or another type of engine), and further includes an air intake 118, a fuel tank 119, a muffler 120, a shroud 122, an engine block 124, and other features and components of the internal combustion engine. In other contemplated embodiments, the prime mover is an electric motor.

According to an exemplary embodiment, both the engine 112 and the pump 116 are coupled to the support frame 114. In some embodiments, the support frame 114 includes a base plate 126, wheels 128, and a handle 130. The engine 112 is fastened to a top of the base plate 126 and the pump 116 is fastened to an underside of the base plate 126. A power take-off (e.g., crankshaft) of the engine 112 may extend through an aperture in the base plate 126 to be coupled to the pump 116, for driving the pump 116.

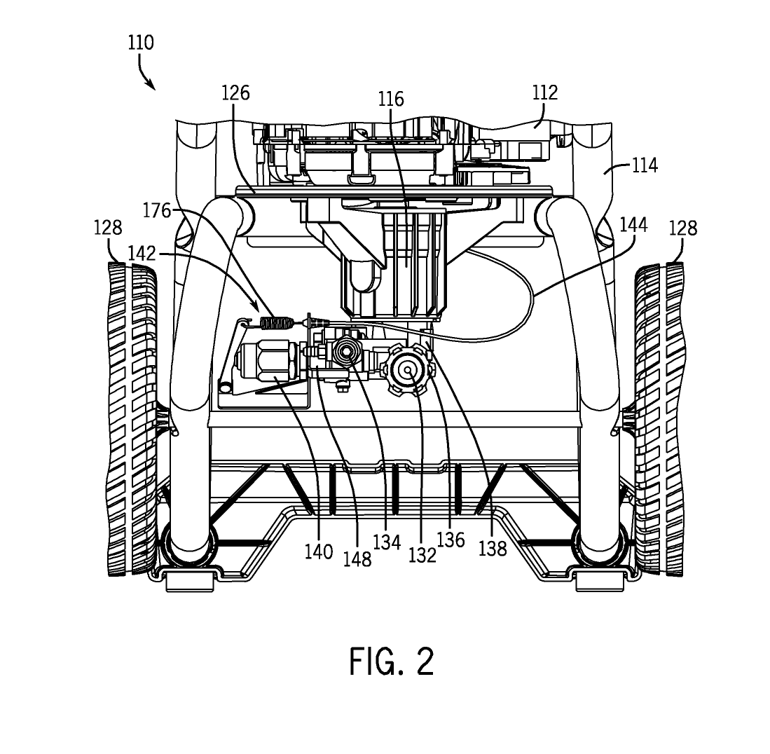

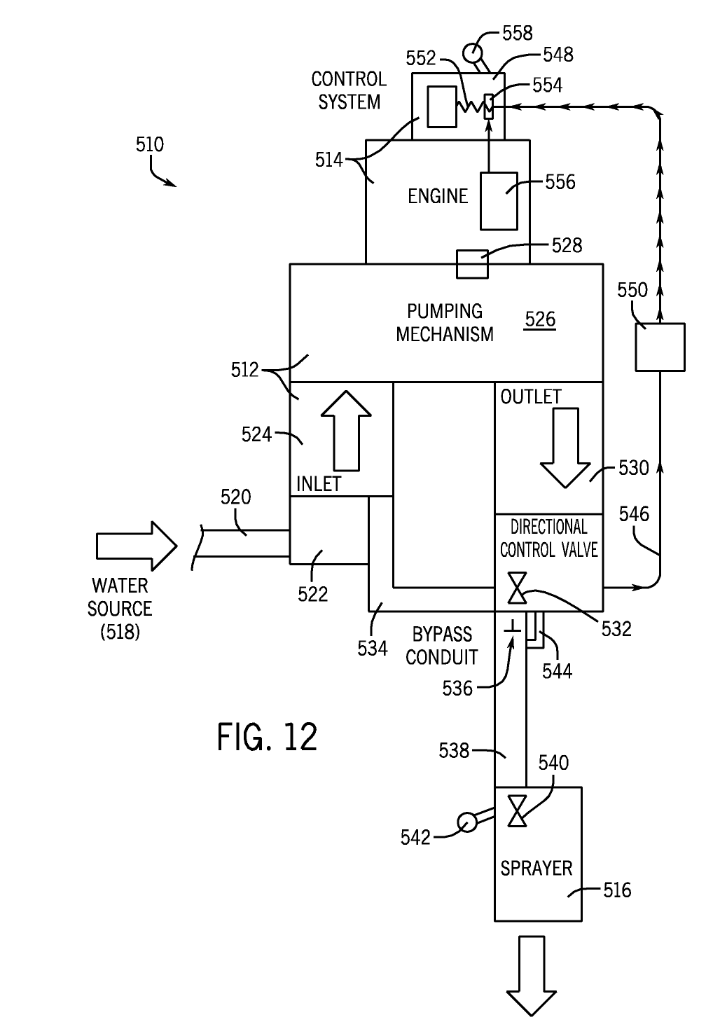

Referring to FIG. 2, the engine 112 drives the pump 116, which includes an inlet 132 and an outlet 134. The inlet 132 may include a garden hose coupling, such as a conventional threaded coupling 136, a quick-connect coupling, or another form of hose coupling. In some embodiments, the pressure washer 110 may additionally include a sprayer (see, generally sprayer 516 as shown in FIG. 12) coupled to the outlet 134 of the pump 116. In some such embodiments, the sprayer is a high-pressure spray gun having a high-pressure hose (see, generally conduit 538 as shown in FIG. 12) used to couple the spray gun to the pump 116.

Between the inlet 132 and the outlet 134, the pump 116 includes a pumping mechanism (internal to housing 138) to pressurize water passing through the pump 116. In some embodiments, the pump 116 includes a radial or axial cam coupled to pistons for pressurizing water (e.g., triplex pump, axial cam pump). The prime mover rotates the cam, which drives the pistons (counter-biased by springs), which then pressurizes the water. In other contemplated embodiments, different types of positive-displacement pumps, centrifugal pumps, or other forms of pumps are used to pressurize the water.

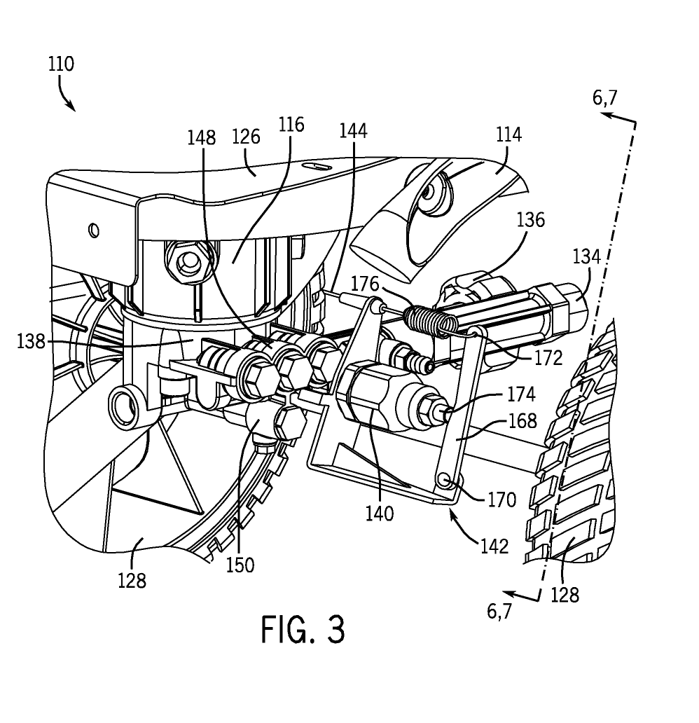

Referring to FIGS. 2-3, the pump 116 further includes an unloader valve 140 and a control mechanism 142 coupled thereto (e.g., control element, control component, controller, feedback device). The unloader valve 140 may be used to divert pressurized water to a recirculation circuit of the pump 116, during times when engine 112 is driving the pumping mechanism but the outlet 134 is blocked, such as when the sprayer is not actively spraying. In some embodiments, the unloader valve 140 is a trapped-pressure unloader, and is actuated by the presence or absence of trapped pressure in the high-pressure hose between the pump 116 and the sprayer (see generally FIG. 12).

According to an exemplary embodiment, the control mechanism 142 is coupled to the unloader valve 140, and is configured to detect the configuration of the unloader valve 140. In some embodiments, the control mechanism 142 detects whether the unloader valve 140 is in an open configuration, recirculation mode, closed setting, the degree to which the unloader valve 140 is open, or other information. The control mechanism 142 is further configured to provide a signal representative of the configuration of the unloader valve 140 (e.g., a translation, a rotation, an electric pulse, a change in movement, etc.).

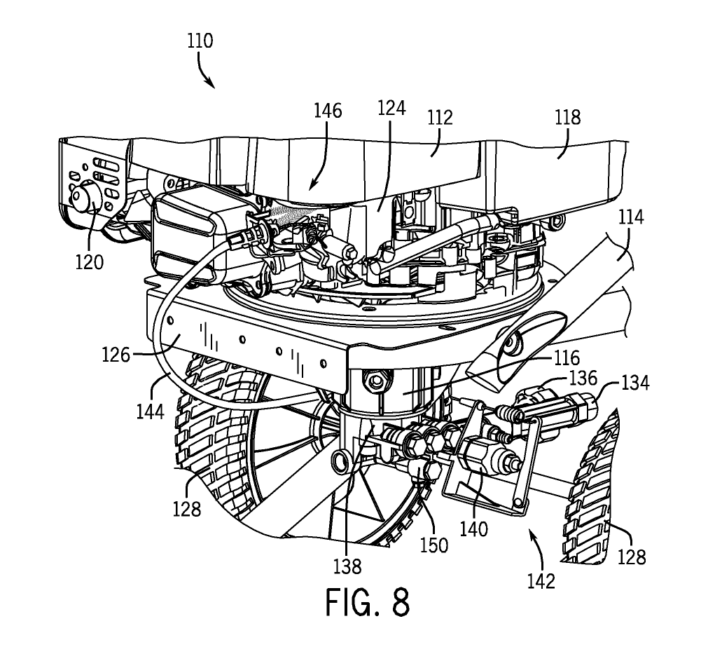

A link (e.g., communication line, electric wire, Bowden cable, physical connection, radio-frequency transceiver, etc.), shown as link 144, extends from the control mechanism 142, and is configured to communicate the signal either directly or indirectly to the engine 112, or other device (e.g., computer, display, etc.). According to an exemplary embodiment, the link 144, at least in part, couples the unloader valve 140 to a speed-control system, such as a throttle system 146 (FIG. 8) of the engine 112 (see also control system 548 as shown in FIG. 12). The signal from the control mechanism 142 is communicated via the link 144 and is used to regulate the speed of the engine 112.

According to an exemplary embodiment, the information provided by the link 144 is used to regulate of the speed of the engine 112 as a function of the configuration of the unloader valve 140. In other contemplated embodiments, an unloader valve is mounted to a pump that is driven by an electric motor, and a link extends from a control mechanism coupled to the unloader valve. The link and control mechanism control the speed of the electric motor. In still other embodiments, the link and control mechanism control a transmission or clutch as a function of the unloader configuration, which selectively couples the motor to the pump.

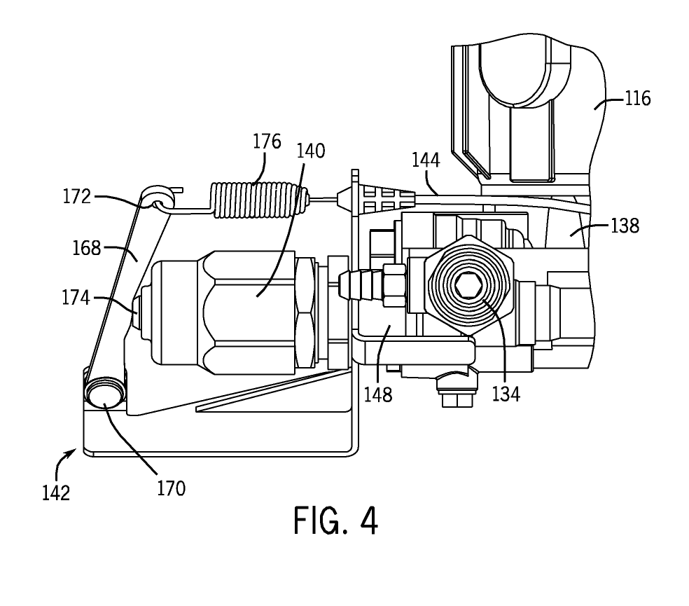

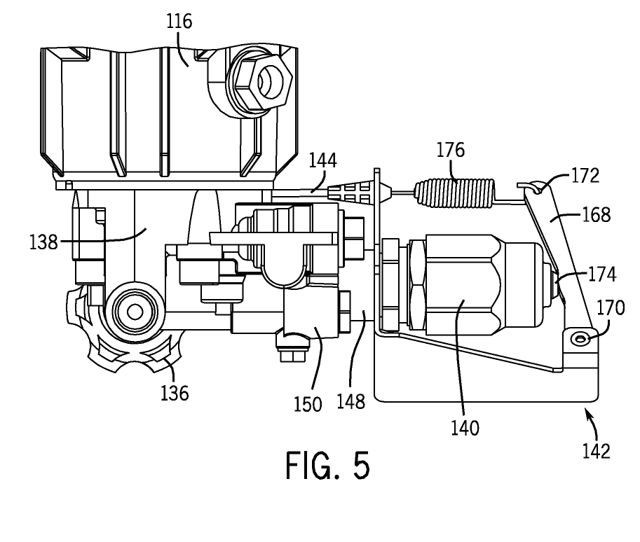

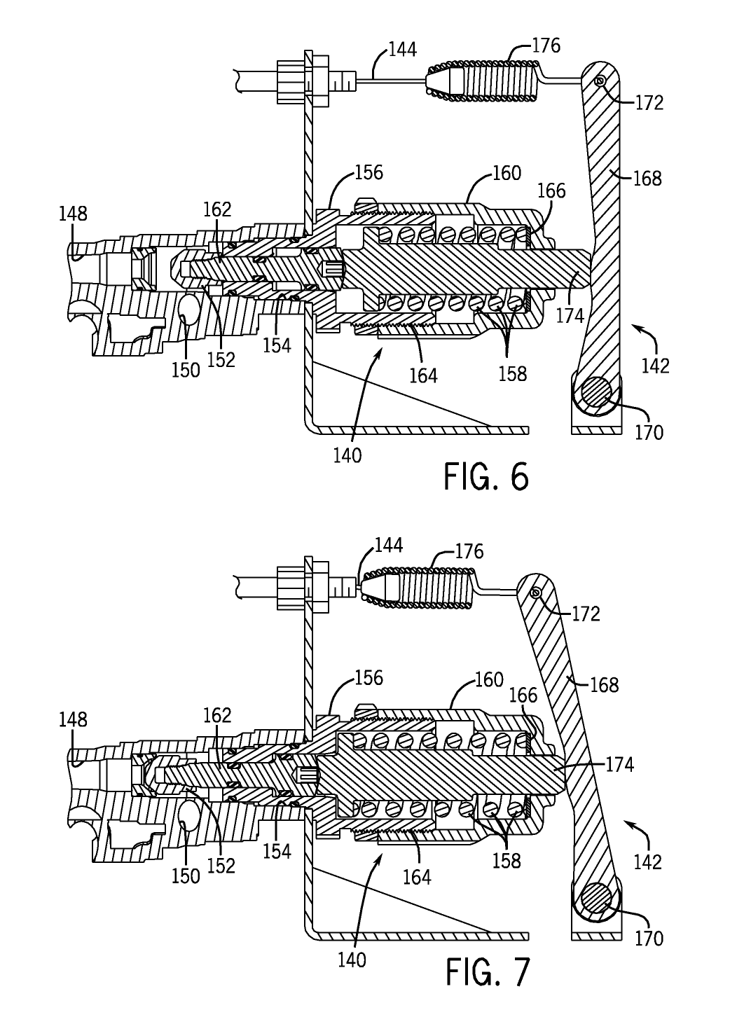

Referring to FIGS. 4-5, the unloader valve 140 may be attached to a discharge manifold 148 of the pump 116, proximate to a bypass conduit 150 that extends between the outlet 134 and the inlet 132 of the pump 116. During attachment of the unloader valve 140, a valve member 152 (e.g., valve gate, valve plug, disc, etc.) (FIGS. 6-7) may be inserted through an opening 154 (FIGS. 6-7) in the discharge manifold 148 or other plumbing of the pump 116. Movement of the valve member 152 controls access to the bypass conduit 150.

Referring now to FIGS. 6-7, the unloader valve 140 includes a housing 156, a spring 158, a spring-load adjustment mechanism 160 (e.g., threaded coupling), and the valve member 152. In some embodiments, the housing 156 of the unloader valve 140 is formed from two or more pieces releasably fastened together (e.g., screwed together). According to an exemplary embodiment, the valve member 152 is fixed to a valve stem 162, which extends longitudinally through the housing 156 of the unloader valve 140. The spring 158 biases the valve member 152 to a position blocking the bypass conduit 150. However, trapped pressure may overcome the bias, moving the valve member 152 and opening the bypass conduit 150 (compare the relative positions of the valve member 152 of FIG. 6 with the valve member 152 of FIG. 7). As shown in FIGS. 6-7, the spring 158 of the unloader valve 140 is positioned within the housing 156, but in other embodiments a spring is positioned outside of the housing of an unloader valve.

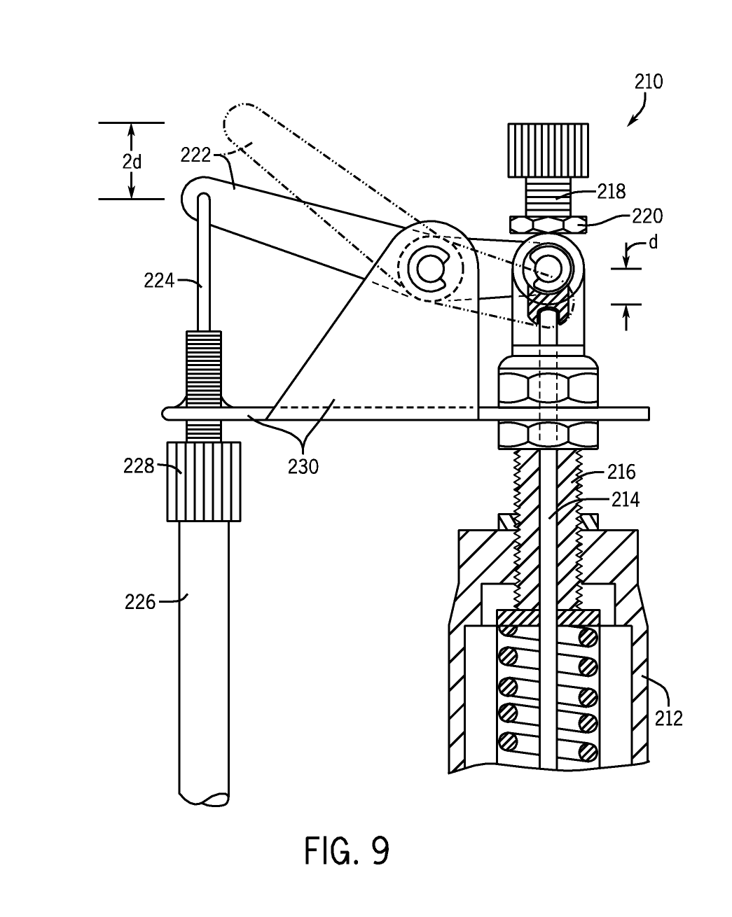

According to an exemplary embodiment, the spring-load adjustment mechanism 160 includes a threaded portion thereof 164. In some exemplary embodiments, the spring-load adjustment mechanism 160 further includes a low-friction, hardened washer 166 or other interior surface adjacent to an end of the spring 158, and a hexagonal exterior periphery configured to be rotated by hand or wrench. During operation of the spring-load adjustment mechanism 160, the threaded portion 164 may be rotated, changing the configuration of the housing 156 and moving the washer 166, in order to increase or decrease loading (e.g., tension, compression, torque) of the spring 158. Accordingly, the amount of loading sufficient to overcome the spring 158 in order to move the valve member 152 is adjustable by the spring-load adjustment mechanism 160. In some embodiments, once a desired spring tension is attained, a jam nut (see, e.g., jam nut 220 as shown in FIG. 9) may be tightened to lock the spring-load adjustment mechanism 160.

During operation of the pressure washer 110, the unloader valve 140 controls fluid access to the bypass conduit 150 in response to a change in the differential of the water pressure internal to the pump 116 relative to the water pressure in the high-pressure conduit between the pump 116 and the sprayer (see, e.g., sprayer 516 and conduit 539 as shown in FIG. 12). When the pump 116 is running but the sprayer is not spraying, back pressure in the high pressure conduit exceeds the water pressure internal to the pump 116 by a sufficient amount, such that the unloader valve 140 opens the bypass conduit 150. In that case, water in the discharge manifold 148 flows back to the inlet 132 through the bypass conduit 150. Recirculation of the water from the discharge manifold 148 to the inlet 132 relieves pressure on components in the pressure washer 110, including the engine 112 and the seals of the high-pressure conduit and sprayer. When the sprayer resumes spraying, the water pressure differential is reduced, and the unloader valve 140 closes the bypass conduit 150. The pressurized water is then directed to and out of the sprayer. The same operation allows for mitigation of pressure fluctuations in the flow, because the unloader valve 140 may partially recirculate pressurized flows exceeding a threshold pressure, while the sprayer is spraying.

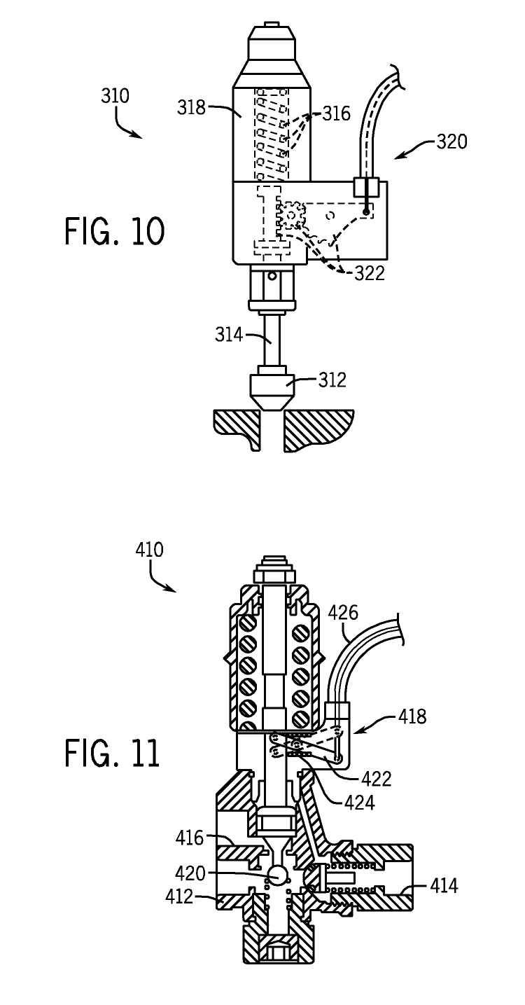

According to an exemplary embodiment, the control mechanism 142 includes a lever arm 168, a fulcrum 170, and a coupling 172 for connection to the link 144 (compare to control mechanism 310 as shown in FIG. 10). The lever arm 168 is positioned in contact with the valve stem 162 or an extension 174 from the valve stem 162. A spring 176 may be included between the coupling 172 to bias the lever arm 168 against the valve stem 162 and extension 174. By way of interaction between the valve member 152, the valve stem 162, the extension 174 from the valve stem 162, and the lever arm 168 of the control mechanism 142; movement of the valve member 152 rotates the lever arm 168, which is relayed to the link 144. As such, movement of the lever arm 168 is converted into a signal that is communicated by the link 144 and which is indicative of the configuration of the unloader valve 140.

According to an exemplary embodiment, the lever arm 168 of the control mechanism 142 serves to condition the signal (e.g., scale, amplify, reduce, invert, filter to a set bandwidth or range of motion, delay, pulse, extrapolate to predict a future behavior, interpolate base upon discrete data points of information, or otherwise condition the signal) produced by the movement of the valve member 152. When the valve member 152 opens the bypass conduit 150 (see FIG. 6), the valve stem 162 and the extension 174 from the valve stem 162 move outward from the housing 156 of the unloader 140. In turn, the lever arm 168 of the control mechanism 142 is rotated about the fulcrum 170. Because the link 144 is coupled to the lever arm 168 at a different distance from the fulcrum 170 than the extension 174, the movement of the valve member 152 received by the lever arm 168 is scaled (e.g., linearly increased or decreased; adjusted according to a set function; amplified; reduced) as the movement is transferred to the link 144. In other embodiments, the relative placement of the link 144 may be adjusted or adjustable to control the degree of scaling. In such embodiments, the link may be placed on the opposite side of the fulcrum, to invert the movement of the valve member. In still other embodiments, more than one link may be coupled to the lever arm, communicating a signal (e.g., instructions to reduce engine speed as shown in FIG. 6, increase engine speed as shown in FIG. 7, engage clutch, release clutch, engage drive train, etc.) to different portions of a system (e.g., throttle and clutch).

According to other contemplated embodiments, inputs other than a change in pressure sensed by the unloader valve 140 may be used to operate the control mechanism 142. In some such embodiments, the control mechanism 142 may be coupled to a check valve associated with the pressure washer, such as a check valve associated with the inlet 132 of the pump 116. The control mechanism 142 may then be configured to detect when flow is passing through the check valve and into the inlet 132 of the pump 116. In other such embodiments, the control mechanism 142 may further include a switch, handle, or dial configured to facilitate manual operation thereof. As such, an operator may be able to manually move (and hold) the lever arm 168 to change the speed of the engine 112 without regard to pressures in the unloader valve 140.

Still referring to FIGS. 4-7, the link 144 includes a Bowden cable having an inner wire (e.g., steel coil) and an outer sheath. One end of the inner wire of the link 144 is connected to the coupling 172 of the control mechanism 142. According to an exemplary embodiment, the other end of the inner wire of the link 144 is coupled to a portion of the speed control system for the engine 112. As the valve member 152 moves in response to changes in the water pressure, the inner wire of the link 144 translates within the outer sheath, communicating movement, position, or orientation of the valve member 152 of the unloader valve 140 to the speed control system.

Referring now to FIG. 8, the link 144 extends from the unloader valve 140 and is coupled to the engine 112. According to an exemplary embodiment, the link 144 is coupled to the throttle system 146 of the engine 112 (see also control system 548 as shown in FIG. 12). In some such embodiments, the link 144 is coupled to a governor spring, which biases a throttle plate of an engine serving as the engine 112. In other embodiments, the link 144 is coupled to a throttle lever or directly to the throttle plate. In still other such embodiments, the link 144 is coupled to a linkage associated with a choke plate of the prime mover, or directly to the choke plate. In some embodiments, the inner wire of the link 144 is coupled to a potentiometer or variable resistor associated with power supplied to an electric motor serving as the prime mover.

While the pressure washer 110 of FIGS. 1-8 is primarily directed to pressurizing and spraying high-pressure water, the disclosure provided herein may be used with a broad range of equipment. In other contemplated embodiments, the power equipment may include an air compressor having an unloader, the air compressor selectively being coupled to a pneumatic power tool, such as a drill, a wrench, a nail gun, or another tool. In still other contemplated embodiments, the power equipment may include a hydraulic pump having an unloader or directional control valve, where the hydraulic pump is configured to control and/or pressurize hydraulic fluid to be delivered to linear actuators (e.g., hydraulic cylinders).

Referring to FIG. 9, a control mechanism 210 is coupled to an unloader valve 212 for a high-pressure pump (see, e.g., pump 116 as shown in FIG. 2). A shaft 214 extends from the valve member (see, e.g., valve member 152 as shown in FIGS. 6-7) and through a spring-load adjustment mechanism 216, which further includes a threaded adjustment member 218 and a jam nut 220. The shaft 214 extends to a lever arm 222 supported by a bracket 230 extending from the unloader valve 212. Movement of the valve member translates the shaft 214, which rotates the lever arm 222. Opposite to the shaft 214 on the lever arm 222, an inner wire 224 of a Bowden cable 226 is coupled to the lever arm 222. As such, movement of the valve member is related to the inner wire 224 of the Bowden cable 226 by way of the lever arm 222, which amplifies the movement (e.g., increases the magnitude according to a set function; linearly increases) and inverts the direction thereof. A barrel adjuster 228 is coupled to the Bowden cable 226 to adjust tension in the inner wire 224. According to an exemplary embodiment, the inner wire 224 is also coupled to a speed control system for an engine (see, e.g., throttle system 146 as shown in FIG. 8) that is driving the high-pressure pump. When the pump is in recirculation mode, the engine is idled.

Referring to FIG. 10, an unloader valve 310 includes a valve member 312, a valve stem 314 fixed thereto, and a spring 316 in a housing 318 biasing the valve member 312. With sufficient pressure, the valve member 312 is moved, allowing flow to pass thereby. A control mechanism 320 including gearing 322 is attached to the valve stem 314 such that when the valve stem 314 translates, the gearing 322 is actuated. In some exemplary embodiments, the gearing 322 amplifies the movement of the valve stem 314. In other embodiments, gearing scales down movement of the valve stem. In still other embodiments, gearing filters movement of the valve stem—only responding to a certain magnitude or range of movement of the valve stem, such as by only placing gear teeth on a limited portion of the valve stem.

Referring to FIG. 11, a trapped-pressure unloader 410 is coupled to a discharge manifold 412 of a high-pressure pump system. When the system is in a through-mode, the unloader 410 allows flow to pass through the discharge manifold 412 to an outlet 414 of the pump. When the system is in a bypass-mode, the unloader directs flow to a bypass conduit 416 directed back to an inlet of the pump. A control mechanism 418 is coupled to the unloader 410 and is configured to detect movement of a valve member 420 of the unloader 410. The movement is received by a lever arm 422 of the control mechanism 418, which rotates about a fulcrum 424. The position of the fulcrum 424 on the lever arm 422 is adjustable, allowing for modification of the factor by which the movement is scaled. The lever arm 422 then relays the movement to a link 426, which communicates the corresponding signal.

Referring now to FIG. 12, a pressure washer system 510 includes a pump 512, a motor 514 (e.g., engine, electric motor) driving the pump 512, and a sprayer 516 or other component for controllably releasing the pressurized water. According to an exemplary embodiment, water from a source 518 is directed to the pump 512 via a hose 520 or other conduit coupled to a connector 522 on an inlet 524 of the pump 512. Once through the inlet 524, the water may be pressurized by a pumping mechanism 526 of the pump 512. The pumping mechanism 526 is coupled to and is driven by a rotational shaft 528 extending from motor 514. Following pressurization, the water passes to the outlet 530 of the pump 512, which has a directional-control valve 532 coupled thereto. The directional-control valve 532 controls access to a bypass conduit 534, which couples the outlet 530 of the pump 512 back to the inlet 524.

When the sprayer 516 is active, the pressurized water flows past the directional-control valve 532, past a check valve 536, and through a high-pressure conduit 538 coupling the outlet 530 of the pump 512 to the sprayer 516. The water then flows through a control valve 540 (e.g., shutoff valve) of the sprayer 516 and out from the sprayer 516 in a controlled manner. The sprayer 516 includes an actuator 542 (e.g., trigger) coupled to the control valve 540, which allows a user to stop the sprayer 516 from actively spraying by releasing the actuator 542.

When the sprayer 516 is not spraying, but the motor 514 and pumping mechanism 526 are active, pressure builds in the conduit 538 between the control valve 540 of the sprayer 516 and the check valve 536. In some embodiments, a pilot conduit 544 couples the water with increased pressure to the directional-control valve 532, causing the directional-control valve 532 to allow water access to the bypass conduit 534. Water from the pumping mechanism 526 is then redirected back to the inlet 524 of the pump 512, in a recirculation circuit. Back pressure holds the directional control valve 532 in the position that opens the bypass conduit 534 until the back pressure is released, such as by releasing the control valve 540 of the sprayer 516 via the actuator 542. In other contemplated embodiments, electronic pressure sensors are used with a directional control valve that is electronically actuated, such as by a solenoid.

The pressure washer system 510 includes a communication link 546 between the directional-control valve 532 and a control system 548 of the motor 514, which may be a direct or indirect link, electrical or wireless, hydraulic, mechanical, etc., or combinations thereof. In one contemplated embodiment, a hydraulic link includes a conduit filled with hydraulic fluid extending between an unloader valve and an engine, where ends of the hydraulic conduit are capped with translatable plungers configured to communicate information between the unloader valve and the engine. In another contemplated embodiment, a mechanical linkage includes a network of rigid mechanical structures configured to transfer movement of a valve member in the unloader valve to a throttle system of an engine. In yet another contemplated embodiment, the link couples the unloader valve to an intermediate component having control circuitry that uses input from the unloader valve, among other sources of data (e.g., time-delay clock), as a part of a logical algorithm to regulate the speed of a motor.

The system 510 further includes a device 550 for conditioning a signal communicated by the link 546. The device 550 may include simple machines, such as levers, gears, pulleys, wheels, sprockets, belts, and the like, to condition the signal. In the contemplated hydraulic-link embodiment discussed in the preceding paragraph, the device 550 includes the plungers and associated conduits which have different cross-sectional areas sized for scaling the signal provided by movement of the unloader valve. In some other contemplated embodiments, movement of the unloader valve is converted to an electromagnetic signal, and the device 550 includes a processor and associated logic modules for scaling, inverting, filtering, delaying, extrapolating, interpolating, or otherwise conditioning the signal. The device 550 may be positioned anywhere along the link 546 including being integrated with the control system 548 for the motor 514.

According to an exemplary embodiment, the control system 548 of the motor 514 includes a governor spring 552, a throttle plate 554, a governor 556, and a throttle lever 558. In some embodiments, the link 546 may be coupled to or able to influence at least one of the governor spring 552, the throttle plate 554, and the throttle lever 558. In an exemplary embodiment, the link 546 is coupled to an end of the governor spring 552, where the throttle lever 558 and a governor 556 are also coupled to the governor spring 552. Tension in the governor spring 552 biases the throttle plate 554 to control the flow of fuel to the motor 514, and thereby controlling the speed of the motor 514. When the directional-control valve 532 opens the bypass conduit 534, the governor spring 552 is loaded to bias the throttle plate 554 to a closed position, idling the motor 514. When the directional-control valve 532 is blocking the bypass conduit 534, the governor spring 552 is loaded to bias the throttle plate 554 to an open position, throttling the motor 514. In contemplated embodiments, components or systems are used to control the motor based upon information provided by the link 346, such as an electronic fuel injection system or an electronic control module.

While embodiments discussed herein may have the signal used to control the speed of the engine, in other contemplated embodiments, the signal may be used to control functions of power equipment other than engine speed such as gear setting, clutch engagement, drivetrain setting, etc. In some contemplated embodiments, the signal is split and sent to multiple parts of the power equipment, such as a user interface, a processor, and a control system for controlling one or more functions of the power equipment. In such embodiments, the split signal may be differently conditioned as the signal is relayed to the multiple parts of the power equipment.

The construction and arrangements of the pressure washer and control system, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A pressure washer, comprising:
a prime mover having a speed control system;
a pump driven by the prime mover during operation of the pressure washer;
an unloader valve coupled to the pump, wherein the unloader valve permits flow to an outlet of the pressure washer when the unloader valve is in a first configuration, and wherein the unloader valve directs the flow through a recirculation circuit when the unloader valve is in a second configuration; and
a control mechanism coupled to the unloader valve;
wherein the control mechanism is configured to receive a signal from the unloader valve that is related to the configuration of the unloader valve;
wherein the control mechanism is configured to condition the signal; and
wherein the control mechanism is configured to communicate the signal to the speed control system, wherein the speed of the prime mover is set at least partially as a function of the signal.

2. The pressure washer of claim 1, wherein the signal received by the control mechanism from the unloader valve is a movement communicated from a portion of the unloader valve.

3. The pressure washer of claim 2, wherein the control mechanism conditions the signal by scaling the movement of the portion of the unloader valve.

4. The pressure washer of claim 3, wherein the control mechanism comprises a lever that amplifies the movement of the portion of the unloader valve.

5. The pressure washer of claim 4, wherein the control mechanism is further comprising a Bowden cable having an inner wire translatable within a sheath, the inner wire coupled to the lever and configured to communicate the signal to the speed control system of the prime mover.

6. The pressure washer of claim 5, wherein the prime mover is an internal combustion engine and the speed control system is a throttle system.

7. The pressure washer of claim 6, further comprising:
a spring member positioned in series with the inner wire of the Bowden cable, the spring member tensioning the inner wire.

8. The pressure washer of claim 7, wherein the inner wire of the Bowden cable is coupled to a throttle plate of the throttle system of the engine, biasing the throttle plate as a function of the configuration of the unloader valve.

9. The pressure washer of claim 8, wherein the signal received by the speed control system idles the engine when the unloader valve is in the second configuration.

10. The pressure washer of claim 9, wherein the unloader valve is fastened to a discharge manifold of the pump, and wherein the pump is at least one of an axial cam water pump, a radial cam water pump, and a triplex water pump.

11. A control system for a pressure washer, comprising:
a valve body having an inlet, a first outlet, and a second outlet, wherein the inlet is configured to be coupled to a manifold of a pump, wherein the first outlet is configured to be coupled to a conduit for receiving pressurized flow from the pump, and wherein the second outlet is configured to be coupled to a recirculation circuit of the pump;
a valve member moveable relative to the valve body and configured to selectively reduce the flow to at least one of the first and second outlets; and
a control mechanism coupled to the valve member, wherein the control mechanism utilizes motion the valve member to at least partially control the engine.

12. The control system of claim 11, wherein the control mechanism at least one of amplifies the movement, inverts the direction of the movement, and converts the movement into an electromagnetic signal.

13. The control system of claim 12, further comprising:
a shaft fixed to the valve member, the shaft extending longitudinally through the unloader valve, and wherein the control mechanism is coupled to the valve member by way of the shaft.

14. The control system of claim 13, wherein the control mechanism comprises a lever that amplifies the movement of the valve member.

15. The control system of claim 14, further comprising:
a Bowden cable comprising an inner wire translatable within a sheath, the inner wire coupled to the lever and configured to communicate the signal to a speed control system of the engine.

16. The control system of claim 15, further comprising:
a bracket fastened to the unloader valve, wherein the bracket supports the Bowden cable and a fulcrum for the lever.

17. The control system of claim 16, further comprising:
a spring positioned in series with the lever and the inner wire of the Bowden cable, providing tension to the inner wire.

18. A method for controlling the speed of an engine, comprising:
detecting a configuration of an unloader valve;
providing a signal indicative of the configuration;
conditioning the signal;
communicating the signal to a throttle system of an engine; and
adjusting the speed of the engine at least partially as a function of the signal.

19. The method of claim 18, wherein the signal is associated with a movement of a valve member of the unloader valve or with a position of the valve member relative to a body of the unloader valve.

20. The method of claim 19, wherein the conditioning step comprises using a lever for scaling the signal by a factor having a magnitude greater than one.

21. The method of claim 20, wherein the communicating step comprises providing a Bowden cable having an inner wire coupled to the lever and to the throttle system for transferring the signal.
